(19) United States
(12) Patent Application Publication
(10) Pub. No.: US 2015/0254402 A1
(43) Pub. Date: Sep. 10, 2015

(54) Consumer Health Score Bureau System and Method to Facilitate a Multi-Sponsor Model of Health Improvement

(71) Applicants: Teresa Ann O'Keefe, Annapolis, MD (US); Ryan Randolph Anderson, Mount Laurel, NJ (US); Marc Anthony Ramdeen, Canton, GA (US); Dhananjay Madhukar Vaidya, Baltimore, MD (US); Jeffery Hunter Young, Baltimore, MD (US)

(72) Inventors: Teresa Ann O'Keefe, Annapolis, MD (US); Ryan Randolph Anderson, Mount Laurel, NJ (US); Marc Anthony Ramdeen, Canton, GA (US); Dhananjay Madhukar Vaidya, Baltimore, MD (US); Jeffery Hunter Young, Baltimore, MD (US)

(21) Appl. No.: 14/200,369

(22) Filed: Mar. 7, 2014

(51) Int. Cl. G06F 19/00; G06Q 30/02

(52) U.S. Cl. CPC G06F 19/322; G06F 19/3431; G06Q 30/0269

(57) ABSTRACT

Certain exemplary embodiments of the invention can provide computer-based systems and methods for an online health service bureau that allows participant consumers to accurately quantify their health by calculating, on behalf of each consumer, a personal health score that is based on each consumer's own measured biomarkers and other related information. The health service bureau may also provide secure mechanisms by which interested third parties, such as employers and insurance companies, can incentivize participant consumers to undertake health-improving activities and thereby improve the consumers' overall health scores, without compromising the privacy of individual consumer identity and health information

### CROSS REFERENCE TO RELATED APPLICATIONS

This application claims priority under 35 U.S.C. §119(e) to U.S. Provisional Patent Application Ser. No. 61/774,017, filed Mar. 7, 2013, which is hereby incorporated by reference.

### BACKGROUND OF THE INVENTION

1. Field of the Invention

The present invention is related to the fields of health score calculation, health information management, and health improvement. More particularly, the present invention is related to systems and methods for constructing and managing online database management systems that contain consumer-specific health information. Even more particularly, the present invention involves systems and methods for calculating consumer health scores and permitting third parties to offer health-improving incentives to the consumers.

2. Description of Related Art

Healthcare providers, insurance companies, and other health professionals have long tried to incentivize consumers to improve their health. One solution, described by Heckerman et al. in U.S. Pat. No. 7,647,285 (“Tools for Health and Wellness”), was to gather health data from a variety of sources and then to use machine-learning algorithms to discover useful patterns in the data. Once the system discovered those patterns, the patterns were used to facilitate consumer self-diagnosis, self-treatment, and where appropriate, to help the consumer identify healthcare professionals to address specific conditions.

Another solution, described by Guillama et al. in U.S. Pat. No. 8,352,408 (“System and Methods for Providing Integrated Wellness Assessment”), involved the generation of an overall health score for individuals. The health score was based on (1) population data; (2) weighting factors relating to specific regions of the body or specific health conditions; (3) individual-specific data pertaining to predetermined health conditions; and (4) a quotient generator for generating an overall health score for the individual from a combination of the weighting factors, the population data, and the individual-specific data.

Still another solution, described by Earles et al. in U.S. Pat. No. 8,374,888 (“Behavior Monitoring and Reinforcement System and Method”), provided a computerized behavior reinforcement system. The system enrolled participants in a behavior reinforcement plan established by a sponsor. Each participant supplied baseline data relating to one or more desired behaviors. Then, on an ongoing basis, the system captured activity data representing the participants' activities. Based on the captured activity data, the system computed individual performance measurements representing how far the participant was progressing towards achievement of one or more desired behaviors.

Despite the benefits provided by the prior art systems, they nevertheless fall short of providing a unified system that accurately measures and quantifies a participant's health; encourages participants to improve their actual health score; and simultaneously provides secure mechanisms by which interested third parties, such as employers and insurance companies, can provide inputs to the health score, validate components of the health score, and incentivize participants to undertake health-improving activities and improve their overall health scores; all without compromising the privacy of individual participant identity and health information.

### BRIEF SUMMARY OF THE INVENTION

This Brief Summary of the Invention is provided to introduce certain concepts in a simplified form that are further described below in the Detailed Description of the Invention. The Summary is not intended to identify key features or essential features of the claimed subject matter, nor is it intended to limit in any way the scope of the claimed invention.

Embodiments of the present invention are directed to computer-based systems and methods for an online health service bureau that allows participant consumers to accurately quantify their health by calculating, on behalf of each consumer, a personal health score that is based on each consumer's own measured biomarkers and other related information. The health service bureau also provides secure mechanisms by which interested third parties, such as employers and insurance companies, can incentivize participant consumers to undertake health-improving activities and thereby improve the consumers' overall health scores, without compromising the privacy of individual consumer identity and health information.

At the core of the health service bureau is a database management system that contains personal health records corresponding to each of the individual consumers. Each personal health record can store many data elements pertaining to a consumer. Some of the data elements concern the consumer's identity. Other data elements concern factors relating more directly to the consumer's health, such as individual health and/or biomarker measurements.

Apart from the personal health records of individual consumers, embodiments of the present invention include a database management system that may also store information about selected health statistics of various population groups. The population health statistics provide reference values that can be used (1) to compare a consumer's individual health measurements to corresponding aggregate health measurements of relevant population groups; and (2) to calculate a consumer's overall health score based on the individual consumer's health measurements and the aggregate health measurements of relevant population groups.

The health score is calculated using a predictive scoring module that accurately measures and quantifies a consumer's health in the form of a single health score. The health score is based on the consumer's individual biomarkers and indicates, with actuarial integrity, the actual preventable health risk of the consumer, relative to other people in a relevant baseline population group, such as individuals of the same sex and age group. The health score of an individual consumer is preferably a single numeric value, which is the output of a mathematical function having a set of input variables that include selected biomarker data elements collected for the consumer, as well as selected aggregate health statistics obtained from population groups. The health score is scaled to a range of 300 to 850 with an average score of approximately 710, in a fashion similar to current scaling ranges of consumer credit scores. A higher health score indicates a healthier individual, while a lower health score indicates a less healthy individual.

In addition to calculating a health score for participant consumers, the health service bureau of the present invention also allows consumers to use their health score as a form of currency, the value of which the consumer can affect by undertaking activities that improve health. Using access control tools provided by embodiments of the invention, a consumer may authorize a third party to acquire information relating to the consumer's personal health record (which may or may not include the health score), according to certain access conditions set by the consumer. For example, a consumer may permit the health service bureau to authorize third parties to issue vouchers to the consumer. A voucher can be redeemed by the consumer at a medical laboratory, for example, for the purpose of collecting a blood specimen, urine specimen, or other specimen from the consumer, measuring the levels of the consumer's biomarkers in the specimen(s), and securely uploading the biomarker measurements to the consumer's personal health record in the health service bureau. In another example, a consumer may authorize the health service bureau to create an electronic relationship between the consumer and a third party, so the third party can offer the consumer a specific product or service (for example, membership in a local CrossFit gym), in order to incentivize the consumer to improve his or her health score. In still another example, the electronic relationship created by a consumer may further include a limited access condition under which a third party may acquire information relating to the consumer's personal health record (for example, an indication of whether the consumer's health score has improved or declined), so the consumer may demonstrate actual improvement in the health score and redeem the third party's offer.

### BRIEF DESCRIPTION OF THE SEVERAL VIEWS OF THE DRAWINGS

FIG. 1 is a high-level block diagram of an exemplary system in accordance with the present invention.

FIG. 2 is a flow diagram of an exemplary embodiment of a method of operating the present invention when the consumer has no sponsors.

FIG. 3 is a flow diagram of an exemplary embodiment of a method of operating the present invention when one sponsor funds a consumer's health score calculation.

FIG. 4 is a flow diagram of an exemplary embodiment of a method of operating the present invention when more than one sponsor offers vouchers to a consumer.

FIG. 5 is a block diagram of an exemplary embodiment of a computing device in accordance with the present invention.

### DETAILED DESCRIPTION OF THE INVENTION

Embodiments of the present invention will be described with reference to the accompanying drawings, wherein like parts are designated by like reference numerals throughout, and wherein the leftmost digit of each reference number refers to the drawing number of the figure in which the referenced part first appears.

### Health Service Bureau

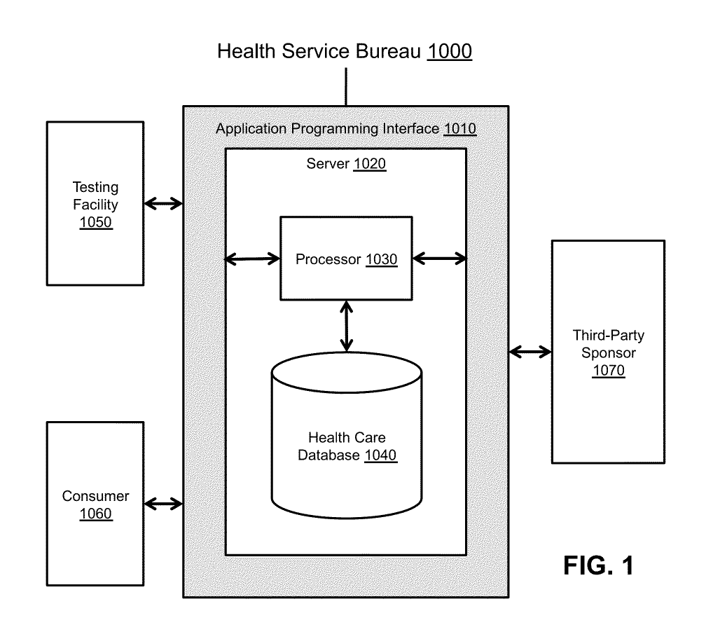

FIG. 1 is a high-level block diagram of an exemplary system in accordance with the present invention. The exemplary embodiments provide a health service bureau 1000 that can employ an Application Programming Interface 1010 (“API”) to manage access to a health care database 1040 for the purpose of providing a consumer 1060 with the ability to determine his or her general health status based on a mathematical combination of biomarker measurements obtained from a testing facility 1050 and aggregate health statistics obtained from population groups. The consumer's general health status is represented in the form of a single value health score.

The health service bureau 1000 also allows the consumer 1060 to authorize a third party sponsor 1070 to generate incentive offers to the consumer 1060 for the purpose of encouraging the consumer 1060 to improve his or her health score. By tying incentive offers to the health score, a third-party sponsor 1070 can leverage the health score to help the consumer 1060 identify areas of health risk and modify related lifestyle behaviors accordingly, thereby improving the consumer's health, decreasing the consumer's risk of experiencing an adverse health event, and lowering overall health management costs.

Still referring to FIG. 1, the health service bureau 1000 includes a server computer 1020 that incorporates a processor 1030 and memory to interact with a health care database 1040. The health care database 1040 can be implemented using any one of a number of database management systems that are known in the art.

Within health care database 1040 are personal health records corresponding to each consumer 1060. Each personal health record will typically store many data elements pertaining to a consumer. Some of the data elements may concern the consumer's identity. These identity elements include, for example, the consumer's name, address, account number, security parameters, user preferences, and the like. Other data elements in the personal health record may concern factors relating more directly to the consumer's health and/or medical condition. Examples of health-related data elements include selected body measurements (e.g., a waist-to-hip ratio), selected biomarker measurements (e.g., HDL cholesterol level), statuses of certain prior medical diagnoses (e.g., whether the consumer has been diagnosed with diabetes), and lists of various drugs and related treatments that the consumer may be receiving (e.g., a blood pressure medication). Some data elements can relate both to identity and health. Examples of such dual-use data elements include birthdate, sex, and gender.

The term “personal health record” is intended to convey a logical collection of data elements that belong to or relate to a given participant consumer. As is the case with the health care database, personal health records may be designed and/or implemented using any number of methods that are well known in the art, including relational techniques. Normally, each individual consumer is assigned one unique personal health record. This is not a requirement, however. Some consumers could be assigned different personal health records, relating, for example, to different periods of time when the consumer has participated in the online health bureau.

A separate part of the health care database 1040 may store selected health statistics corresponding to various population groups. These population health statistics are aggregate values, such as statistical averages, which correspond to the same physical and biomarker measurements that are taken of each individual consumer, but are reflective of certain population groups as a whole, rather than individuals. Examples of population groups include (1) males between the ages of 15 and 20; (2) females between the ages of 15 and 20; (3) males between the ages of 20 and 25; (4) females between the ages of 20 and 25, etc. The aggregate health measurements of population groups may be organized and grouped by age, sex, gender, or other categories.

Application Programming Interface 1010 (“API”) may be a collection of software routines and modules that together enable a consumer 1060, a third-party sponsor 1070, or a testing facility 1050 to communicate with the health service bureau 1000 over a network such as the Internet. The Application Programming Interface 1010 may be implemented by any number of means known in the art, and may include, for example, Common Gateway Interface (“CGI”) scripts, Java scripts, HTML code, and other similar tools and techniques.

### Mathematical Algorithm to Generate the Health Score

The health service bureau 1000 of the present invention uses a computing device to determine a health score of a consumer 1060 based on a discrete set of human biomarker values, certain physical measurements of the consumer's body, and other information about the consumer. The health score quantifies certain modifiable components of health, and enables consumers to track their health as they modify their lifestyle and health behaviors to maximize their well-being.

Certain health factors associated with mortality have been identified using evidence from prospective cohort studies of selected populations. The identified health factors fall into categories representing, for example, lipid levels, blood pressure, insulin resistance, cardiac function, kidney function, and tobacco smoke exposure. These identified health factors, in addition to other factors, have been combined to create the following list of factors that the health service bureau 1000 may use to calculate a health score of an individual consumer:
Age (or birthdate), sex, and gender. Note that for purposes of the present invention, the term “sex” is intended to describe a biological characteristic related to a particular complement of sex chromosomes, whereas the term “gender” is intended to describe a lifestyle and/or behavior, perhaps enhanced by physical and/or hormonal modifications. While age, sex, and gender do not directly contribute to the health score, each of the other measured factors—which do contribute to the health score—may be adjusted for age, sex and gender.
Height and weight, body mass index, and/or waist-to-hip ratio.
Systolic blood pressure and/or diastolic blood pressure, typically measured in millimeters of Mercury (mmHg).
Total cholesterol and/or high-density lipid (“HDL”) cholesterol, typically measured in milligrams per deciliter (mg/dL).
Brain natriuretic peptide (“BNP”), now known as B-type natriuretic peptide or Ventricular Natriuretic Peptide (a measure of cardiac function), typically measured in picograms per milliliter (pg/mL).
Creatinine (a measure of kidney function), typically measured in milligrams per deciliter (mg/dL).
Cotinine (a measure of exposure to tobacco smoke), typically measured in nanograms per milliliter (ng/mL).
HbA1C (a measure of blood glucose level, which can indicate Diabetes), typically measured as a percentage.

Some of the identified health factors can be manipulated in short periods of time. For example, weight can be temporarily lowered through the use of diuretics. However, such short-term manipulations of weight are believed not to have a significant influence on the health score. Blood pressure, total cholesterol, and possibly BNP can be lowered in the short-term using anti-hypertensive and lipid-lowering medications, respectively. It is therefore possible for an individual consumer to use such medications to influence the health score, but then not to adhere to those medications over the long-term. HDL, HbA1c, and creatinine are also minimally modifiable in the short-term.

Diagnoses can have a strong impact on health risk but are difficult to validate. For the purpose of risk stratification, insurers can use administrative data to identify diagnoses, which can be combined with the health score calculated by the present invention in order to create stratifications of risk. The health score can thus serve as a measure of treatment effectiveness in those individual consumers who have conditions that impact specific health factors.

Some of the health factors can be influenced by exposures to substances that are not directly measured. For example, individuals using nicotine replacement but who are not currently smoking can have measurable cotinine levels. Furthermore, just as specific treatments can improve risk factor levels and simultaneously lower the risk of future adverse health events, treatments can also improve measurements of health score factors.

A consumer's health score will be subject to change as new health factors or score components are determined to result in a more accurate health score. (The term “health factor,” as used herein is intended to have the same meaning as the term “score component.”) In part for this reason, the health score may exist as a procedure in the health service bureau 1000 that is called on demand when a consumer's health score is accessed by the consumer or a third-party sponsor, and will be subject to change as new coefficients of variables in the health score are determined to be more accurate than existing ones.

The health service bureau 1000 can determine a health score of a consumer using the following mathematical calculations:

Each of the health score components above is numbered 1 through k. Of the k components identified and used in the score calculation, the 1^{st}, 2^{nd}, . . . , i^{th}, . . . k^{th} components are symbolized as x₁, x₂, . . . xᵢ, . . . xₖ in the formulae below. Thus, for example, x₁ could indicate systolic blood pressure. The population aggregate scores for each of the score components are symbolized as x̅₁, x̅₂, . . . x̅ᵢ, . . . x̅ₖ. Thus, continuing the above example, x̅₁ would indicate the aggregate systolic blood pressure of a given population group.

Population groups may be organized by age, sex, gender, and other criteria. In these situations, a consumer's age, sex, and/or gender, etc. may be used as an index into the stored population aggregate scores, to extract the specific population aggregate score x̅ᵢ that is appropriate for a given consumer.

In some embodiments, a date and/or time stamp may be associated with certain health score components, because the measurements of those components may be assumed to be accurate and current for only a short period of time, for example 90 days.

The first step of the health score calculation takes the difference between the consumer's individual measurement for a given score component and the population aggregate for that same score component: (xᵢ− x̅ₗ). The difference calculation is performed for each of the components used in the score calculation.

The next step is to multiply the difference between the consumer's score for a component and the population aggregate for that score component by an e log-hazard risk coefficient βᵢ (in base e) associated with the score component in the relevant population group. This step is repeated for each of the components in the score calculation.

Then, a raw hazard ratio (H) is determined for the individual consumer with respect to the population average, by summing all of the differences (xᵢ− x̅ₗ), as adjusted by their respective e log-hazard risk coefficients βᵢ, and then using that summed value as an exponent to the base e, to remove the logarithmic scale and produce a raw hazard ratio, as shown in the following equation:

H=e^{Σ}^{ᵢ₌₁}^{^{k}}^{{β}^{ᵢ}^{(x}^{ᵢ}^{- x̅}^{ₗ}^{)}}

As may be noted, the raw hazard ratio H will equal 1 when all score components of the individual are equal to their respective population average scores, since e⁰=1.

Finally, the raw hazard ratios are rescaled to the range 300-850 using an asymmetric algebraic transformation, such that the population average score is approximately 710 on the scaled score. The asymmetric algebraic transformation is further constructed such that there is a greater range of scores for relatively unhealthier persons below the population average (300-709) as compared to relatively healthier persons above the population average (711-850). This rescaling allows the score to be used as a metric to motivate relatively unhealthier individuals to have a greater range of improvement in the rescaled score. It also results in a score that is similar in range to the distribution of FICO credit scores, which are widely known and accepted in public use as an indication of financial wellness.

Health Score=(H)_{rescaled to 300-850 range}

This mathematical algorithm is used by at least one embodiment of the invention. Other treatments and refinements of the algorithm are possible, especially as new advances are made in the fields of biomarker technology and epidemiology.

### Modifications to the Health Score Algorithm

One alternative way of calculating the raw hazard ratio (H) uses a Blom Transform rather than an exponential-logarithmic calculation, as shown in the following equation:

$$H = Blom Transform \{ {\sum }_{i = 1}^{k} [ {β}_{i} ( {x}_{i} - \overline{{x}_{i}} ) ] \}$$

The Blom transformation is a well-known method of converting numbers that are not distributed in a Gaussian (or normal) distribution to a distribution that is Gaussian. The preferred embodiment of the present invention uses e log-hazard risk coefficients because they produce a distribution of scores that is more similar to the distribution of FICO credit scores. However, other methods of distributing scores, such as the Blom transformation and the probit transformation, are known in the art and are within the scope of the present invention.

Each population aggregate score for a score component may comprise any one of several different aggregate calculations. One example of an aggregate score is a simple average, often called the arithmetic average, of all the scores obtained from a population group. Another example of an aggregate score is a geometric mean of all scores obtained from a population group. Yet another example is a harmonic mean of all scores obtained from a population group.

Some health score components can be “categorized,” which means the xᵢ measurement is the categorized value (say, 0 or 1) and the corresponding x̅ᵢ value is the fraction of the population in that category (say 0.5 to represent 50% smokers).

Some health score components may be received via a testing facility 1050 (see FIG. 1) that has obtained a specimen from the participant consumer. Other health score components may be received by affidavit or self-reporting by the consumer or other reporting entity. Still other health score components may be received from direct-connect devices that transmit immediate measurements to the health service bureau through the connection shown in FIG. 1 between consumer 1060 and the Application Programming Interface 1010.

### Obtaining Statistical Health Parameters of a Population

Before calculating a health score of a participant consumer, embodiments of the present invention may receive and store in the health care database 1040 a set of aggregate scores, where each aggregate score x̅ᵢ corresponds to one health score component of a population group. As an example, one aggregate score could be the arithmetic average of all systolic blood pressure measurements gathered from a population of females between the ages of 20 and 25. The aggregate score can be loaded into the health care database 1040 by processor 1030, executing software provided by the Application Programming Interface 1010, or alternatively by executing software provided by the health care database 1040. The specific method for loading aggregate scores can be selected from any one of a number of well-known methods in the art. Perhaps the simplest method is for an operator to enter aggregate scores into the health care database 1040 by hand, using a keyboard and a standard interface for entering data. Another method could involve importing aggregate scores from another data source, such as a spreadsheet or another database management system.

Health Service Bureau in Operation without Sponsors

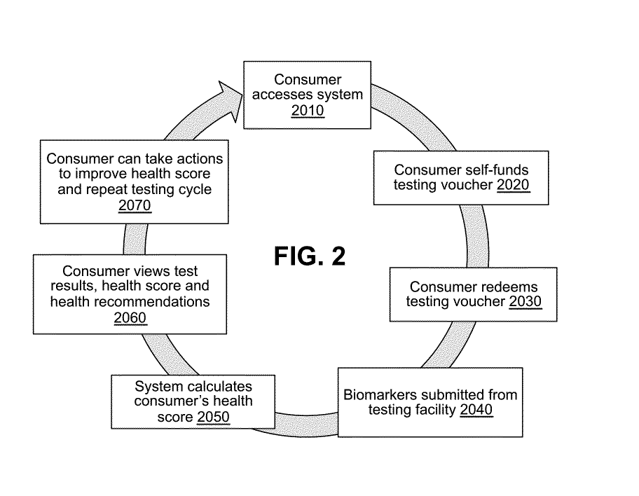

FIG. 2 is a flow diagram of an exemplary embodiment of a method of operating health service bureau 1000 when the consumer has no sponsors. At step 2010, a consumer (see item 1060 of FIG. 1) initially accesses the health service bureau 1000 through a user interface that communicates with Application Programming Interface 1010. At step 2010, the consumer may perform such initial activities as logging in, creating an account, and setting user preferences. At step 2020, if the consumer does not have a sponsor, the consumer may self-fund a testing voucher. A testing voucher is a document, preferably an electronic document, that is transmitted by the health service bureau 1000 to a testing facility 1050 for the purpose of authorizing and enabling the test facility 1050 to perform biometric screening tests on the consumer; that is, to measure the consumer's health score components by collecting a blood specimens, urine specimens, or other specimens from the consumer, measuring the levels of the consumer's biomarkers in the specimen(s), and securely uploading the biomarker measurements through the Application Programming Interface 1010 to the corresponding health score component fields of the consumer's personal health record in the health care database 1040 of the health service bureau 1000.

At step 2030 of FIG. 2, the consumer 1060 redeems the testing voucher at the testing facility 1050 by visiting the testing facility 1050, providing proof of identification (which may include various security measures) and submitting requested specimens and other health-related information (for example, height, weight, and other body measurements, such as hip and waist measurements) to the testing facility 1050. The testing facility 1050 then performs the necessary laboratory tests on the consumer's specimen(s) to isolate and measure the specific biomarkers required by the health information bureau 1000. The results of the tests are then sent using a secure transmission protocol to the health service bureau 1000, where they are received at step 2040.

At step 2050 of FIG. 2, the processor 1030 of the health information bureau 1000 calculates the consumer's health score using any one of the algorithms disclosed herein. The consumer 1060 then uses a user interface to communicate with Application Programming Interface 1010 at step 2060 to view the test results, the calculated health score, and any health-related recommendations offered by the health service bureau 1000. At step 2070, the consumer 1060 may then take actions to improve the health score and repeat the testing cycle by purchasing a new testing voucher at step 2020.

Health Service Bureau in Operation with a Sponsor

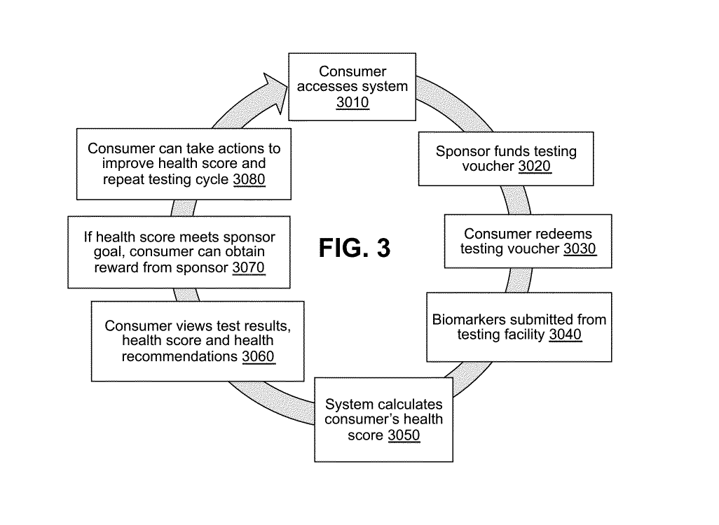

FIG. 3 is a flow diagram of an exemplary embodiment of a method of operating health service bureau 1000 when a sponsor funds the consumer's health score calculation. At step 3010, a consumer (see item 1060 of FIG. 1) initially accesses the health service bureau 1000 through a user interface that communicates with Application Programming Interface 1010. At step 3010, the consumer may perform such initial activities as logging in, creating an account, and setting user preferences. At step 3020, a third-party sponsor 1070 may fund a testing voucher to encourage the consumer to be tested so that a health score for the consumer can be generated. The third-party sponsor 1070 funds a testing voucher by communicating to the health service bureau 1000 through the Application Programming Interface 1010 to create a voucher offer, which the health service bureau 1000 then sends to the consumer 1060. If the consumer 1060 accepts the offer, the health service bureau 1000 then transmits the voucher to a testing facility 1050 for the purpose of authorizing and enabling the test facility 1050 to perform biometric screening tests on the consumer; that is, to measure the consumer's health score components by collecting a blood specimens, urine specimens, or other specimens from the consumer, measuring the levels of the consumer's biomarkers in the specimen(s), and securely uploading the biomarker measurements through the Application Programming Interface 1010 to the corresponding health score component fields of the consumer's personal health record in the health care database 1040 of the health service bureau 1000.

At step 3030 of FIG. 3, the consumer 1060 redeems the testing voucher at the testing facility 1050 by visiting the testing facility 1050, providing proof of identification, and submitting requested specimens and other health-related information (for example, height, weight, and other body measurements, such as hip and waist measurements) to the testing facility 1050. The testing facility 1050 then performs the necessary laboratory tests on the consumer's specimen(s) to isolate and measure the specific biomarkers required by the health information bureau 1000. The results of the tests are then sent using a secure transmission protocol to the health service bureau 1000, where they are received at step 3040.

At step 3050 of FIG. 3, the processor 1030 of the health information bureau 1000 calculates the consumer's health score using any one of the algorithms disclosed herein. The consumer 1060 then uses a user interface to communicate with Application Programming Interface 1010 at step 3060 to view the test results, the calculated health score, and any health-related recommendations offered by the health service bureau 1000. At step 3070, the health service bureau 1000 may compare the consumer's health score to a health score goal that has been set by the third-party sponsor 1070. If the consumer's health score matches or exceeds the health score goal set by the third-party sponsor 1070, the consumer may then obtain a reward from the sponsor. Rewards issued by third-party sponsors can range from monetary rewards, to reductions in health insurance costs, to discounts on health-related products and services. Finally, at step 3080, the consumer 1060 may then take actions to improve the health score and repeat the testing cycle by purchasing a new testing voucher at step 3020.

Health Service Bureau in Operation with Multiple Sponsors

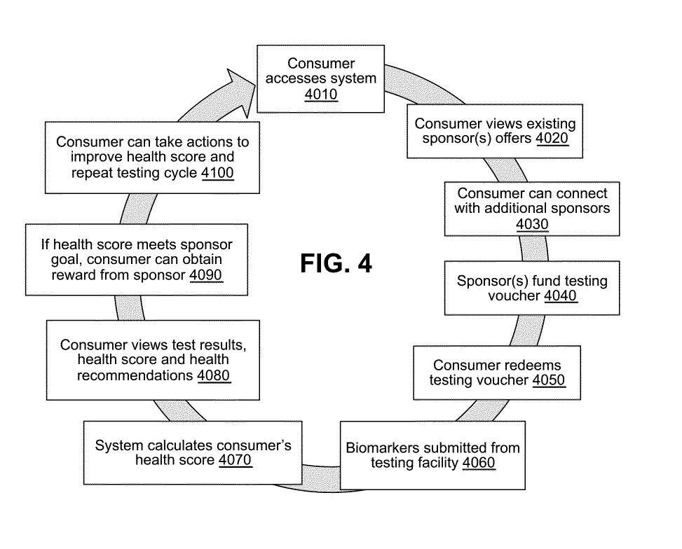

FIG. 4 is a flow diagram of another exemplary embodiment of a method of operating health service bureau 1000 when more than one sponsor offers vouchers to a consumer. At step 4010, a consumer (see item 1060 of FIG. 1) initially accesses the health service bureau 1000 through a user interface that communicates with Application Programming Interface 1010. At step 4010, the consumer may perform such initial activities as logging in, creating an account, and setting user preferences.

At step 4020 a consumer may view offers from any one of a plurality of third-party sponsors 1070. At step 4030, the consumer may connect with an additional third-party sponsor who may make an additional offer to the consumer. The additional offer may comprise a condition, which if met, will enable to the consumer to receive a monetary award, a reduction in health insurance costs, a discount on health-related products and services, and the like. The conditions supplied in an offer issued by a third-party sponsor may include, for example, getting an annual physical, attending an exercise or yoga class on a regular basis, participating in a diet program, agreeing to quit smoking, agreeing to modify diet, or any other similar health-improving activity.

At step 4040, a third-party sponsor 1070 may fund a testing voucher to encourage the consumer to be tested so that a health score for the consumer can be generated. The third-party sponsor 1070 funds a testing voucher by communicating to the health service bureau 1000 through the Application Programming Interface 1010 to create a voucher offer, which the health service bureau 1000 then sends to the consumer 1060. If the consumer 1060 accepts the offer, the health service bureau 1000 then transmits the voucher to a testing facility 1050 for the purpose of authorizing and enabling the test facility 1050 to perform biometric screening tests on the consumer; that is, to measure the consumer's health score components by collecting a blood specimens, urine specimens, or other specimens from the consumer, measuring the levels of the consumer's biomarkers in the specimen(s), and securely uploading the biomarker measurements through the Application Programming Interface 1010 to the corresponding health score component fields of the consumer's personal health record in the health care database 1040 of the health service bureau 1000.

At step 4050 of FIG. 4, the consumer 1060 redeems the testing voucher at the testing facility 1050 by visiting the testing facility 1050, providing proof of identification, and submitting requested specimens and other health-related information (for example, height, weight, and other body measurements, such as hip and waist measurements) to the testing facility 1050. The testing facility 1050 then performs the necessary laboratory tests on the consumer's specimen(s) to isolate and measure the specific biomarkers required by the health information bureau 1000. The results of the tests are then sent using a secure transmission protocol to the health service bureau 1000, where they are received at step 4060.

At step 4070 of FIG. 4, the processor 1030 of the health information bureau 1000 calculates the consumer's health score using any one of the algorithms disclosed herein. The consumer 1060 then uses a user interface to communicate with Application Programming Interface 1010 at step 4080 to view the test results, the calculated health score, and any health-related recommendations offered by the health service bureau 1000. At step 4090, the health service bureau 1000 may compare the consumer's health score to a health score goal that has been set by the third-party sponsor 1070. If the consumer's health score matches or exceeds a health score goal set by one of the third-party sponsors 1070, the consumer may then obtain a reward from the sponsor. As mentioned above, rewards issued by third-party sponsors can range from monetary rewards, to reductions in health insurance costs, to discounts on health-related products and services. Finally, at step 4100, the consumer 1060 may then take actions to further improve the health score and repeat the testing cycle.

### Secure Access to Consumer Health Records

As mentioned above, the health care database 1040 may hold personal health records corresponding to each consumer 1060. The consumer 1060 may establish access permissions and thereby control all access to the consumer's personal health record, including the consumer's health score. A consumer 1060 may set up their own personal health record in the health service bureau 1000, or the consumer 1060 may authorize a qualified third party to input the consumer's biomarker information and/or receive access to the consumer's health score or information in aggregate as a component of a larger population of consumers.

A relationship between a consumer and a third party may be defined and authorized by the consumer. Such a relationship is an electronic one, specified by limited access conditions and other consumer-specific parameters, whereby a third party may be permitted by the relationship to receive information about a consumer. One example of a limited access condition is a consumer's permission for a third party to receive aggregate information compiled by the health service bureau 1000 about a group of consumers including the consumer granting the limited access. Under this example, a third party could receive the starting and ending average health scores of all participants who participate in a given offer. The third party might also be able to receive an aggregate indication of whether the group of participating consumers improved their health scores, and by how much, as a group.

Another example of a limited access condition is the consumer's permission to allow a third party to generate offers to the consumer. Still another example of a limited access condition is the consumer's authorization of a third party as being qualified to access the consumer's personal health record, again under certain limited access conditions.

Qualified third parties may be given limited access to consumer's personal health records through secure procedures based on compliance guidelines. A qualified third party with proper permissions can input, either directly or through an application program interface 1010, consumer health information that the third party previously collected as a biometric measurement or performed tests on a specimen for results.

A qualified third party with proper security can have limited access to a consumer's data where a relationship has been defined by the health service bureau 1000 and where the consumer provides explicit permission to access his/her personal health record.

A qualified third party with proper security can be provided limited access to a population's data, in aggregated and anonymous form, where the population has been defined through a relationship in the system.

An ecommerce module of the health service bureau 1000 enables a qualified third party to sponsor vouchers for biometric screenings, or other products and services, for eligible consumers within the system.

An eligibility module in the health service bureau 1000 enables input from a qualified third party where the third party presents data and/or criteria to connect with consumers, in order to create a relationship, where, in turn, the system presents the third-party sponsor to consumers and establishes a relationship with consumers in the system, either based on an existing external relationship (e.g. as an employer) or as a new relationship where the consumer proactively chooses to establish a relationship with the presented third-party sponsor through the system.

Embodiments of the present invention enable a consumer to a) establish a relationship with a third party-sponsor by accepting the presentation of a voucher for a screening; b) purchase a biometric screening through ecommerce mechanisms; and c) present a voucher as a scan-readable image on a computer device or printed image, to a qualified third party biometric testing organization, such as testing facility 1050.

Communications between the consumer 1060 and the Application Programming Interface 1010 of the health service bureau 1000, between a third party sponsor and the Application Programming Interface 1010 of the health service bureau 1000, and between a testing facility and the Application Programming Interface 1010 of the health service bureau 1000 may all be made secure by adherence to security protocols, cryptographic techniques, and other forms of secure communications known in the art. To facilitate secure forms of communication, the personal health record of a consumer may comprise a list of a authorized third parties and public keys for each third party, for use in public key cryptographic communications. Communications may further be implemented using the Simple Object Access Protocol (“SOAP”), the Secure Socket Tunneling Protocol (“SSTP”), or any similar protocols known in the art.

### Additional Features and Benefits of the Invention

An individual's human biomarkers are a powerful tool to determine the general health status of a consumer and can be used to predict the current and future risk of having a health event. The managed sharing of health score information according to methods of the present invention is intended to reduce the level of asymmetric risk information between consumers and employers or health care service providers (third-party sponsors), and to facilitate exposure to consumers of lifestyle choices that can have a measurable effect on the consumer's health score. For example, adequate health information could facilitate sponsors in determining populations where additional screening, education and incentives are needed to assist high-risk individuals before conditions require more expensive intervention. This information helps sponsors to assess a population's risk levels, determine the effectiveness of internal health programs, and reduce mid to long term health expenses.

Health scores calculated and used in the present invention are based on the different expected risks of various biomarker variations. Consumers with poor health scores or biometric histories will incur higher medical costs over time and will have a higher risk of health event occurrences than consumers who have a higher health score and improved biometric histories. Additionally, decision-makers in areas unrelated to a consumer's health, such as those who must estimate utilization costs, will increasingly need access to better predictors of population health and predictive risk, as studies have shown that certain biometrics have predictive value. At the same time, consumers can also benefit from a good health Score from a centralized bureau, as it will give them access to a standardized measure of their health and risk that can be used for potential benefits and savings, and also as a tool to expose and educate consumers about the impact that various actions can have on their health and thereby prompt consumers to take more personal responsibility.

The health service bureau 1000 provides biometric screenings to consumers. Consumers can control what data, if any, is released to their sponsor(s). The data provided by the consumer, as well as their biometric screening data, is then aggregated into the health care database 1040. The results of any biometric screening performed on a consumer will be available on request, for the purposes of reviewing medical history, risk levels, and the resulting health scores generated or updated after each screening. The consumer can also choose to release their health score to a sponsor for usage as notified to the consumer by the sponsor.

In the context of the present invention, a third party sponsor may be a health insurance company, a health care provider, an exercise facility, a weight loss company, an employer, or similar entity.

A third party may offer different kinds of incentives to a consumer. One kind of incentive is participation-based, where a third party is able to review which consumers accepted an offer and elected to participate in it. Another kind of offer is outcome-based, where the third party will receive an indication of whether a consumer accepted an offer and then either achieved a certain health score or improved their health score by a certain number of points (either absolute or in terms of percentage). In certain third-party offers, the third party may be permitted by the consumer to view the consumer's health score and other information stored in the consumer's personal health record. In other third-party offers, however, the consumer may permit a third party to view only aggregate information about all the consumers who elected to accept the offer and participate in it.

The health service bureau 1000 maintains a device agnostic user experience for consumers to track biomarkers and other personal health information, learn about biomarkers, how their health score compares to other similar populations, explore related health topics, and interact with various modules of the system.

The health service bureau 1000 employs a predictive method for calculating a consumer's individual health score. The system may perform the health score calculation on demand, as the consumer's health score is accessed. Alternatively, the system may perform a new health score calculation and then store the resulting health score whenever one or more new score components, including new biomarker measurements, is received. The health score is based on the consumer's biomarkers received by the system, and indicates, with actuarial integrity, the actual preventable health risk of the consumer, relative to others of the same sex and age group.

The health service bureau 1000 may enable consumers to track other personal health information that relates to their health score, such as medications, health events and personal habits or other conditions.

The health service bureau 1000 may enable consumers to learn about their health score through content provided in the system.

The health service bureau 1000 may have a computer-based advocate module to interact with a consumer and deliver evidence-based advice and interaction through secure email, text and avatars.

The health service bureau 1000 may facilitate population-based contests and social exchange between users that have common traits or sponsors.

### Computing Device

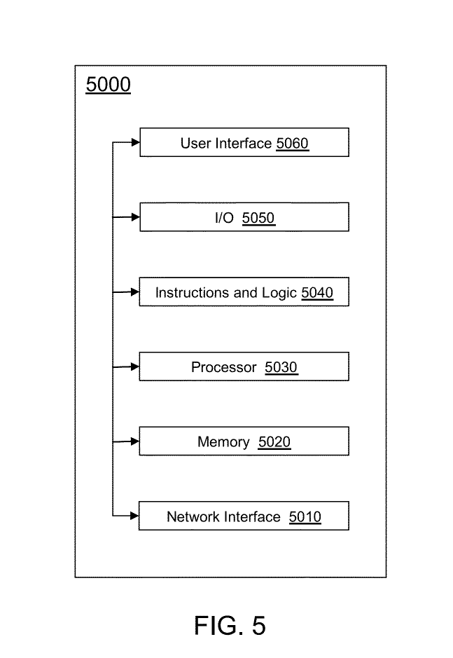

FIG. 5 is a block diagram of an exemplary embodiment of a computing device 5000 in accordance with the present invention, which in certain operative embodiments can comprise, for example, the health service bureau 1000, the server 1020, computers used by the testing facility 1050, computers used by the consumer 1060, and computers used by the third party sponsor 1070 of FIG. 1. Computing device 5000 can comprise any of numerous components, such as for example, one or more network interfaces 5010, one or more memories 5020, one or more processors 5030 including program instructions and logic 5040, and one or more input/output (I/O) devices 5050 enabling one or more user interfaces 5060 that may be coupled to the I/O device(s) 5050, etc.

Computing device 5000 may comprise any device known in the art that is capable of processing data and/or information, such as any general purpose and/or special purpose computer, including as a personal computer, workstation, server, minicomputer, mainframe, supercomputer, computer terminal, laptop, tablet computer (such as an iPad), wearable computer, mobile terminal, Bluetooth device, communicator, smart phone (such as an iPhone, Android device, or BlackBerry), a programmed microprocessor or microcontroller and/or peripheral integrated circuit elements, an ASIC or other integrated circuit, a hardware electronic logic circuit such as a discrete element circuit, and/or a programmable logic device such as a PLD, PLA, FPGA, or PAL, or the like, etc. In general any device on which resides a finite state machine capable of implementing at least a portion of a method, structure, API, and/or user interface described herein may be used as a computing device. A computing device can comprise components such as one or more network interfaces, one or more processors, one or more memories containing instructions, and/or one or more input/output (I/O) devices, one or more user interfaces coupled to an I/O device, etc.

Memory 5020 can be any type of apparatus known in the art that is capable of storing analog or digital information, such as instructions and/or data. Examples include a non-volatile memory, volatile memory, Random Access Memory, RAM, Read Only Memory, ROM, flash memory, magnetic media, hard disk, floppy disk, magnetic tape, optical media, optical disk, compact disk, CD, digital versatile disk, DVD, and/or RAID array, etc. The memory device can be coupled to a processor and/or can store instructions adapted to be executed by processor, such as according to an embodiment disclosed herein.

Input/output (I/O) device 5050 may comprise any sensory-oriented input and/or output device known in the art, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.

Instructions and logic 5040 may comprise directions adapted to cause a machine, such as a computing device, to perform one or more particular activities, operations, or functions. The directions, which can sometimes form an entity called a “processor”, “kernel”, “operating system”, “program”, “application”, “utility”, “subroutine”, “script”, “macro”, “file”, “project”, “module”, “library”, “class”, “object”, or “Application Programming Interface,” etc., can be embodied as machine code, source code, object code, compiled code, assembled code, interpretable code, and/or executable code, etc., in hardware, firmware, and/or software. Instructions and logic 5040 may reside in processor 5030 and/or memory 5020.

Network interface 5010 may comprise any device, system, or subsystem capable of coupling an information device to a network. For example, a network interface can be a telephone, cellular phone, cellular modem, telephone data modem, fax modem, wireless transceiver, Ethernet circuit, cable modem, digital subscriber line interface, bridge, hub, router, or other similar device.

Processor 5030 (including processor 1030 in FIG. 1) may comprise a device and/or set of machine-readable instructions for performing one or more predetermined tasks. A processor can comprise any one or a combination of hardware, firmware, and/or software. A processor can utilize mechanical, pneumatic, hydraulic, electrical, magnetic, optical, informational, chemical, and/or biological principles, signals, and/or inputs to perform the task(s). In certain embodiments, a processor can act upon information by manipulating, analyzing, modifying, converting, transmitting the information for use by an executable procedure and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium IV series of microprocessor manufactured by the Intel Corporation of Santa Clara, Calif. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein.

User Interface 5060 may comprise any device and/or means for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, auto-sizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.

The present invention can be realized in hardware, software, or a combination of hardware and software. The invention can be realized in a centralized fashion in one computer system, or in a distributed fashion where different elements are spread across several interconnected computer systems. Any kind of computer system or other apparatus adapted for carrying out the methods described herein is suitable. A typical combination of hardware and software can be a general-purpose computer system with a computer program that, when being loaded and executed, controls the computer system such that it carries out the methods described herein.

The present invention, as already noted, can be embedded in a computer program product, such as a computer-readable storage medium or device which when loaded in a computer system is able to carry out the different methods described herein. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

The foregoing disclosure has been set forth merely to illustrate the invention and is not intended to be limiting. It will be appreciated that modifications, variations and additional embodiments are covered by the above teachings and within the purview of the appended claims without departing from the spirit and intended scope of the invention. Other logic may also be provided as part of the exemplary embodiments but are left out here so as not to obfuscate the present invention. Since modifications of the disclosed embodiments incorporating the spirit and substance of the invention may occur to persons skilled in the art, the invention should be construed to include everything within the scope of the appended claims and equivalents thereof.

1. An online health service bureau, comprising:
a server including a processor, a memory, and a database management system, the server capable of network communication with a consumer, a biomarker testing facility, and a third-party sponsor;
means for receiving into the database management system via an application programming interface a plurality of population biomarker values, each population biomarker value corresponding to an aggregate measurement of a selected biomarker of a population group;
means for creating a personal health record for the consumer in the database management system;
means for receiving the birth date and sex category of the consumer;
means for receiving from the biomarker testing facility a set of consumer biomarker values of the consumer;
means for adding the received consumer biomarker values to the personal health record;
means for calculating a health score of the consumer based on the birth date, the sex category, the consumer biomarker values, and the population biomarker values;
means for recording the health score of the consumer in the personal health record;
means for creating a relationship between the consumer and the third party sponsor, where the relationship includes a limited access condition under which the third party sponsor may acquire information relating to the personal health record;
means for allowing the third party sponsor to acquire the information relating to the personal health record according to the limited access condition;
means for receiving from the third party sponsor an offer to supply a product or service to the consumer;
means for transmitting the offer to the consumer; and
means for enabling the consumer to accept the offer.

2. The online health service bureau of claim 1, wherein the consumer biomarker values comprise a measure of adiposity; a measure of systolic blood pressure; a measure of total cholesterol; and a measure of HDL cholesterol.

3. The online health service bureau of claim 1, wherein the consumer biomarker values comprise a measure of brain natriuretic peptide.

4. The online health service bureau of claim 1, wherein the consumer biomarker values comprise a measure of creatinine.

5. The online health service bureau of claim 1, wherein the consumer biomarker values comprise a measure of cotinine.

6. The online health service bureau of claim 1, wherein the consumer biomarker values comprise a measure of hemoglobin A1C.

7. The online health service bureau of claim 1, wherein the information relating to the personal health record comprises the health score of the consumer.

8. The online health service bureau of claim 1, wherein the information relating to the personal health record comprises an anonymous aggregate of health score values derived from a plurality of consumers.

9. The online health service bureau of claim 1, wherein the health score of the consumer is recalculated whenever any of the consumer biomarker values are updated.

10. The online health service bureau of claim 1, wherein the means for allowing the third party sponsor to acquire the information relating to the personal health record is governed by access permissions set by the consumer.

11. The online health service bureau of claim 1, wherein the offer comprises a voucher that can be redeemed at the biomarker testing facility for a biometric testing procedure.

12. The online health service bureau of claim 1, wherein the offer comprises an opportunity to receive a discount for a health benefit.

13. The online health service bureau of claim 1, wherein the offer is based on the health score of the consumer.

14. The online health service bureau of claim 1, wherein the health score is a scaled hazard ratio for the consumer with respect to the population biomarker values.

15. The online health service bureau of claim 14, wherein the hazard ratio is calculated according to the following equation: H=e^{Σ}^{ᵢ₌₁}^{^{k}}^{{β}^{ᵢ}^{(x}^{ᵢ}^{- x̅}^{ₗ}^{)}}.

16. The online health service bureau of claim 15, wherein the hazard ratio is scaled using an asymmetric algebraic transformation that yields an average score of approximately 710, a maximum score of 850, and a minimum score of 300.

17. A method for improving consumer health scores, comprising:
receiving, from a biomarker testing facility over a network, a plurality of consumer biomarker measurements for a consumer;
storing the plurality of consumer biomarker measurements in a personal health record of the consumer, where the personal health record is located in a database management system on a server connected to the network;
calculating, in the server, a health score of the consumer based on the consumer's birth date, the consumer's sex category, the plurality of consumer biomarker measurements, and a corresponding plurality of aggregate population biomarker measurements;
recording the health score in the personal health record;
creating a relationship between the consumer and a third party sponsor, where the relationship is recorded in the personal health record and includes a limited access condition under which the third party sponsor may acquire information relating to the personal health record; and
allowing the third party sponsor to acquire the information relating to the personal health record according to the limited access condition.

18. The method of claim 17, further comprising receiving from the third party sponsor an offer to supply a product or service to the consumer based on the acquired information relating to the personal health record.

19. The method of claim 18, further comprising transmitting the offer to the consumer over the network.

20. The method of claim 19, further comprising enabling the consumer to accept the offer.
